(19) United States
(12) Patent Application Publication
(10) Pub. No.: US 2024/0072638 A1
(43) Pub. Date: Feb. 29, 2024

(54) Driving Circuit and Switching Power Supply

(71) Applicant: ROHM CO., LTD., KYOTO (JP)

(72) Inventors: Isao TAKOBE, KYOTO (JP); Junki OTANI, KYOTO (JP)

(21) Appl. No.: 18/359,170

(22) Filed: Jul. 26, 2023

(30) Foreign Application Priority Data
Aug. 24, 2022 (JP) 2022-133146
Feb. 7, 2023 (JP) 2023-016510

(51) Int. Cl. H02M 1/088; H02M 3/158

(52) U.S. Cl. CPC H02M 1/088; H02M 3/1588

(57) ABSTRACT

The present disclosure provides a driving circuit. The driving circuit includes a first transistor, a second transistor and a controller. The first transistor and the second transistor are configured to be connected in parallel between a control end of a transistor to be driven (i.e., an application end of an upper gate signal) and an application end of an on-voltage. The controller is configured to turn on the first transistor at the beginning of an on-transition period of the transistor to be driven and turn on the second transistor in the middle of the period.

### TECHNICAL FIELD

The present disclosure relates to a driving circuit and a switching power

### BACKGROUND

Switching power supplies are equipped in various devices (for example, referring to patent document 1).

### PRIOR ART DOCUMENT

### Patent Publication

[Patent document 1] Japan Patent Publication No. 2021-191109

### BRIEF DESCRIPTION OF THE DRAWINGS

FIG. 1 is a diagram of a configuration example of a switching power supply.

FIG. 2 is a diagram of an operation example of a switching power supply.

FIG. 3 is a diagram of switching loss (Ron loss).

FIG. 4 is a diagram of a driving circuit according to a first embodiment.

FIG. 5 is a diagram of an example of a loss reduction operation according to the first embodiment.

FIG. 6 is a diagram of a driving circuit according to a second embodiment.

FIG. 7 is a diagram of an example of a loss reduction operation according to the second embodiment.

FIG. 8 is a diagram of a driving circuit according to a third embodiment.

FIG. 9 is a diagram of a situation in which ringing of a gate signal occurs.

FIG. 10 is a diagram of a situation in which ringing of a gate signal is inhibited.

FIG. 11 is a diagram of a situation in which a deviation of ON-timing control occurs.

FIG. 12 is a diagram of a driving circuit according to a fourth embodiment.

FIG. 13 is a diagram of a situation in which a deviation of ON-timing control is relieved.

### DETAILED DESCRIPTION OF THE EMBODIMENTS

### <Switching Power Supply>

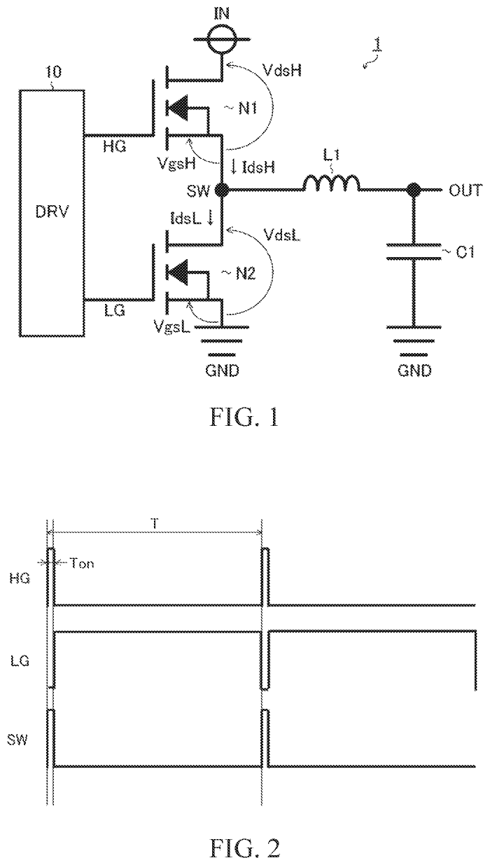

FIG. 1 shows a diagram of a configuration example of a switching power supply. In this configuration example, a switching power supply 1 is a non-insulated direct-current/direct-current (DC/DC) converter that steps down an input voltage IN to generate an output voltage OUT. As depicted in the drawing, the switching power supply 1 includes an output transistor N1 (for example, an N-channel type metal oxide semiconductor field effect transistor (NMOSFET)), a synchronous rectifier transistor N2 (for example, an NMOSFET), a capacitor C1, an inductor L1 and a driving circuit 10.

The drain of the output transistor N1 is connected to an application end of the input voltage IN. The source of the output transistor N1, the drain of the synchronous rectifier transistor N2 and the first end of the inductor L1 are all connected to an application end of a switching voltage SW. The second end of the inductor L1 and the first end of the capacitor C1 are both connected to an application end of the output voltage OUT. The source of the synchronous rectifier transistor N2 and the second end of the capacitor C2 are both connected to a ground terminal (=an application end of a ground voltage GND). The respective gates of the output transistor N1 and the synchronous rectifier transistor N2 are both connected to an output end of the driving circuit 10 (respective application ends of an upper gate signal HG and a lower gate signal LG).

In the switching power supply 1 of this configuration example, when the upper gate signal HG is at a high level and the lower gate signal LG is at a low level, the output transistor N1 is turned on, and the synchronous rectifier transistor N2 is turned off. At this point in time, the switching voltage SW becomes at a high level (=IN).

On the other hand, when the upper gate signal HG is at a low level and the lower gate signal LG is at a high level, the output transistor N1 is turned off and the synchronous rectifier transistor N2 is turned on. At this point in time, the switching voltage SW becomes at a low level (=GND).

As such, the output transistor N1 and the synchronous rectifier transistor N2 that form a half-bridge output stage are turned on/off in a complementary manner according to the upper gate signal HG and the lower gate signal LG. As a result, the switching voltage SW is pulse driven between the input voltage IN and the ground voltage GND. The inductor 11 and the capacitor C1 rectifies and smooths the switching voltage SW in rectangular wave to generate the output voltage OUT.

Moreover, in the switching power supply 1 having the half-bridge output stage, switching loss (Ron loss) is generated in both of the output transistor N1 and the synchronous rectifier transistor N2.

FIG. 2 shows a diagram of an operation example (in a low duty cycle) of the switching power supply 1. In this drawing, the upper gate signal HG, the lower gate signal LG and the switching voltage SW are depicted sequentially from top to bottom.

In the recent years, as an advanced technique for improving the power density of a step-down DC/DC converter, the applicant of the present application proposed an ultra-high-speed pulse control technique (Nano Pulse Control™) capable of setting an extremely low on duty cycle Don. Furthermore, the on duty cycle Don is defined as a ratio of an on time Ton of the output transistor N1 to a switching period T (=Ton/T).

Moreover, GaN devices are emerging as a method to meet high power requirements of the market of power supply integrated circuits in recent years. For example, GaN devices can be used as the output transistor N1 and the synchronous rectifier transistor N2 described above. The gate-source threshold voltage of GaN devices is generally 10 V or less.

For example, when the foregoing Nano Pulse Control™ is used for drive control of the output transistor N1 implemented by a GaN device, a minimum value of the on time Ton of the output transistor N1 can be set to be less than 20 ns (several ns to 20 ns).

However, the gate capacitance of a GaN device is less than the gate capacitance of a Si device. Thus, a GaN device has switching loss, which is caused by the gate capacitance, less than that of a Si device, and so switching loss (Ron loss) caused by an on resistance can become significant in a GaN device. In particular, when a GaN device is driven in a low duty cycle, the Ron loss appears especially large.

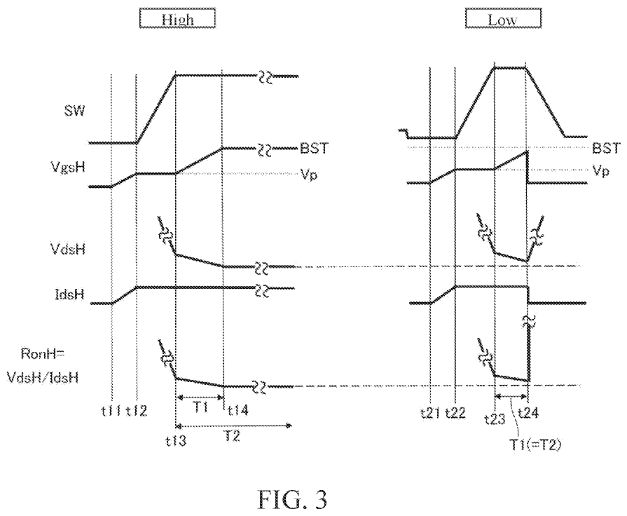

FIG. 3 shows a diagram of switching loss (Ron loss) of the switching power supply 1. In this drawing, a switching voltage SW, and a gate-source voltage VgsH, a drain-source voltage VdsH, a drain-source current IdsH, and an on resistance RonH (VdsH/IdsH) of the output transistor N1 are sequentially depicted from top to bottom.

The drain-source voltage VdsH and the on resistance RonH are depicted in an enlarged manner in the vertical-axis direction. Moreover, the left of this drawing represents behaviors in a high duty cycle, and the right of this drawing represents behaviors in a low duty cycle.

Referring to the left of this drawing, behaviors in a high duty cycle are first described. At a timing t11, when the gate-source voltage VgsH of the output transistor N1 begins to rise, the drain-source current IdsH starts to flow. At this point in time, the switching voltage SW is kept at a low level (≈GND).

At a timing t12, when the increase in the drain-source current IdsH ends, the drain-source voltage VdsH begins to drop. Along with the drop of the drain-source voltage VdsH, the switching voltage SW rises and the on resistance RonH drops.

Moreover, at the timing t12, the gate-source voltage VgsH becomes temporarily stagnant around a plateau voltage Vp. This operating region (=timings t12 to t13) in which the gate-source voltage VgsH rises slowly is generally referred to as a plateau region. In addition, the plateau region may be understood as a charging period of an accompanying gate capacitance between the gate and the drain of the output transistor N1.

At the timing t13, the gate-source voltage VgsH again rises when the plateau region of the output transistor N1 expires, and the drain-source voltage VdsH continues to drop slowly in comparison with the plateau region described above. Along with the drop of the drain-source voltage VdsH, the on resistance RonH also drops slowly in a corresponding manner.

At a timing t14, the gate-source voltage VgsH reaches a bootstrap voltage BST, and the drain-source voltage VdsH and the on resistance RonH reach respective minimum values. That is to say, the output transistor N1 becomes fully turned on.

However, when the on resistance RonH is not fully dropped to the minimum value during the Ron loss period T (=timings t13 to t14) in this drawing, the drain-source current IdsH flows. Thus, switching loss (Ron loss) of the output transistor N1 is generated.

However, due to the high duty cycle, the high-level period T2 (=timing t13 and onward) of the switching voltage SW is much longer than the Ron loss period T1 (T1<<T2). That is to say, the ratio of the Ron loss period T1 to the high-level period T2 (=T1/T2) is extremely small. Therefore, the switching loss (Ron loss) is unlikely significant.

Referring to the right of this drawing, behaviors in a low duty cycle are described. Behaviors between timings t21 and t23 (=behaviors up to when the plateau region expires) are the same as the behaviors between the timings t11 and t13 described above. Thus, behaviors after the timing t23 are described in detail below.

At the timing t23, when the plateau region of the output transistor N1 expires, the on resistance Ron also drops slowly in a corresponding manner as the drain-source voltage VdsH drops. This behavior is the same as the behavior in a high duty cycle.

However, in a low duty cycle, transition of turning off of the output transistor N1 may begin before the output transistor N1 becomes fully turned on. According to this drawing, at a timing t24, the high-level period T2 of the switching voltage SW expires before the drain-source voltage VdsH and the on resistance RonH reach their respective minimum values. Thus, in the example of this drawing, the Ron loss period T1 is consistent with the high-level period T2 of the switching voltage SW (T1=T2).

As such, in a low duty cycle, the ratio of the Ron loss period T1 to the high-level period T2 (=T1/T2) increases. Therefore, the switching loss (Ron loss) easily becomes significant.

In the description below, in view of the consideration above, a driving circuit 10 capable of reducing the switching loss (Ron loss) in a low duty cycle is provided.

### <Driving Circuit (First Embodiment)>

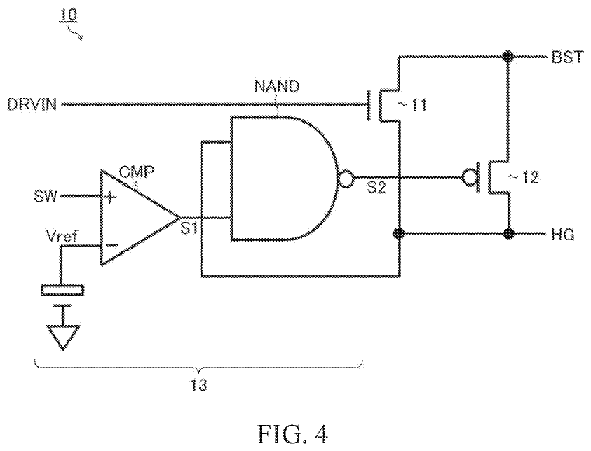

FIG. 4 shows a diagram of the driving circuit 10 according to a first embodiment. The driving circuit 10 of this embodiment includes a transistor 11 (equivalent to a first transistor, for example, an NMOSFET), a transistor 12 (equivalent to a second transistor, for example, a P-channel type MOSFET (PMOSFET)), and a controller 13.

The drain of the transistor 11 and the source of the transistor 12 are both connected to an application end of a bootstrap voltage BST (=SW+Vc, where Vc is a charging voltage of a bootstrap capacitor (not shown)). The source of the transistor 11 and the drain of the transistor 12 are both connected to an application end of the upper gate signal HG.

As such, the transistors 11 and 12 are connected in parallel between the gate of the output transistor N1 and the application end of the bootstrap voltage BST. Moreover, when observing from the driving circuit 10, the output transistor N1 is equivalent to a transistor to be driven. In addition, the bootstrap voltage BST is equivalent to an ON voltage of the output transistor N1.

The transistor 11 may also be an N-channel type (equivalent to a first channel type), and the transistor 12 may then be a P-channel type (equivalent to a second channel type different from the first channel type).

A driving input signal DRVIN is applied to the gate of the transistor 11. Thus, the transistor 11 is turned on when the driving input signal DRVIN is at a high level (for example, BST), and is turned off when the driving input signal DRVIN is at a low level (for example, HG). In addition, the driving input signal DRVIN can be generated by means of acquiring the output voltage OUT from the input voltage IN by an output feedback circuit (not shown).

A negative logic product signal S2 (to be described in detail shortly) is applied to the gate of the transistor 12. Thus, the transistor 12 is turned off when the negative logic product signal S2 is at a high level (for example, BST), and is turned on when the negative logic product signal S2 is at a low level (for example, HG).

The controller 13 turns on the transistor 11 at beginning of an on-transition period of the output transistor N1, and also turns on the transistor 12 in the middle of the on-transition period so as to generate the foregoing negative logic product signal S2.

According to this drawing, the controller 13 includes a comparator CMP and a negative logic product gate NAND.

The comparator CMP compares the switching voltage SW input to a non-inverting input terminal (+) with a predetermined threshold voltage Vref (for example, IN−5 V) input to an inverting input terminal (−) to generate a comparison signal S1. Thus, the comparison signal S1 becomes at a high level when the switching voltage SW is higher than the threshold voltage Vref, and becomes at a low level when the switching voltage SW is lower than the threshold voltage Vref.

The negative logic product gate NAND (equivalent to a logic gate) generates, according to the comparison signal S1 and the upper gate signal HG (equivalent to a control signal of the transistor to be driven), the negative logic product signal S2 to turn on/off the transistor 12. The negative logic product signal S2 becomes at a high level when at least one of the comparison signal S1 and the upper gate signal HG is at a low level, and becomes at a low level when both the comparison signal S1 and the upper gate signal HG are at a high level.

As such, the controller 13 of this configuration example determines an ON timing of the transistor 12 according to a comparison result between the switching voltage SW appearing at one end (the source) of the output transistor N1 and the predetermined threshold voltage Vref.

According to this drawing, the controller 13 turns on the transistor 12 when the switching voltage SW is higher than the threshold voltage Vref and the upper gate signal HG is at a high level (=the logic level when ON).

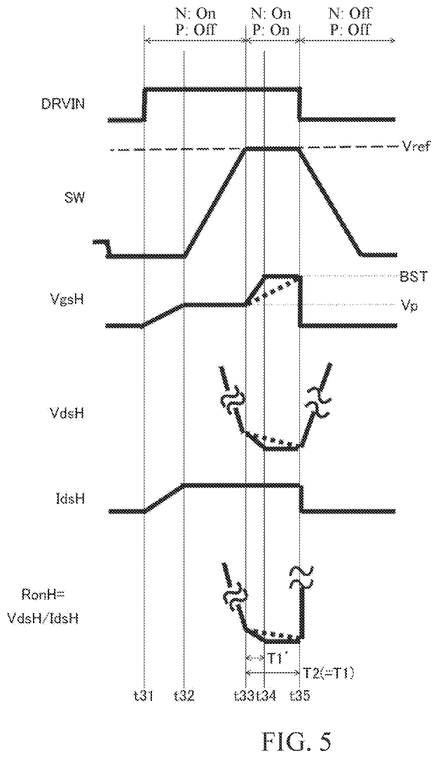

FIG. 5 shows a diagram of an example of a loss reduction operation according to the first embodiment. In this drawing, the driving input signal DRVIN, the switching voltage SW, and the gate-source voltage VgsH, the drain-source voltage VdsH, the drain-source current IdsH, and the on resistance RonH (=VdsH/IdsH) of the output transistor N1 are sequentially depicted from top to bottom.

The drain-source voltage VdsH and the on resistance RonH are depicted in an enlarged manner in the vertical-axis direction. Moreover, similar to the right of FIG. 3 described above, this drawing represents behaviors in a low duty cycle.

At a timing t31, the transistor 11 is turned on when the driving input signal DRVIN rises to a high level. As a result, when the gate-source voltage VgsH of the output transistor N1 begins to rise, the drain-source current IdsH starts to flow. At this point in time, the switching voltage SW is kept at a low level (≈GND<Vref). Accordingly, the transistor 12 is kept as off.

At a timing t32, when the increase in the gate-source current IdsH ends, the drain-source voltage VdsH begins to drop. Along with the drop of the drain-source voltage VdsH, the switching voltage SW rises and the on resistance RonH drops.

Moreover, at the timing t32, the gate-source voltage VgsH becomes temporarily stagnant (plateau region) around the plateau voltage Vp.

At a timing t33, the gate-source voltage VgsH again rises when the plateau region of the output transistor N1 expires, and at this point in time, the switching voltage SW reaches the threshold voltage Vref. Accordingly, in addition to the transistor 11, the transistor 12 is also turned on. As a result, the gate-source voltage VgsH rises drastically in comparison with the prior behaviors (equivalent to the right of FIG. 3) as indicated by the dotted line. Moreover, the drain-source voltage VdsH and the on resistance RonH also drop drastically in comparison with the prior behaviors as indicated by the dotted lines.

At a timing t34, the gate-source voltage VgsH reaches a bootstrap voltage BST, and the drain-source voltage VdsH and the on resistance RonH reach their respective minimum values. That is to say, the output transistor N1 becomes fully turned on.

At a timing t35, both the transistor 11 and the transistor 12 are turned off when the driving input signal DRVIN drops to a low level, and the high-level period T2 of the switching voltage SW expires.

In the series of operations of loss reduction, only the transistor 11 is turned on at the beginning of the on-transition period (=timings t31 to t33) of the output transistor N1, and the transistor 12 is also turned on in the middle (=timing t33) of the on-transition period of the output transistor N1.

As a result, the on resistance RonH is minimized within a shorter time after the plateau region expires. Thus, a Ron loss period T1′ (=timings t33 to t34) is shortened compared to the conventional Ron loss period T1 (=timings t33 to t35). In other words, the Ron loss period T1′ is shorter than the high-level period T2 (=timings t33 to t35) of the switching voltage SW (T1′<T2=T1). Therefore, the prior switching loss (Ron loss) is unlikely significant.

### <Driving Circuit (Second Embodiment)>

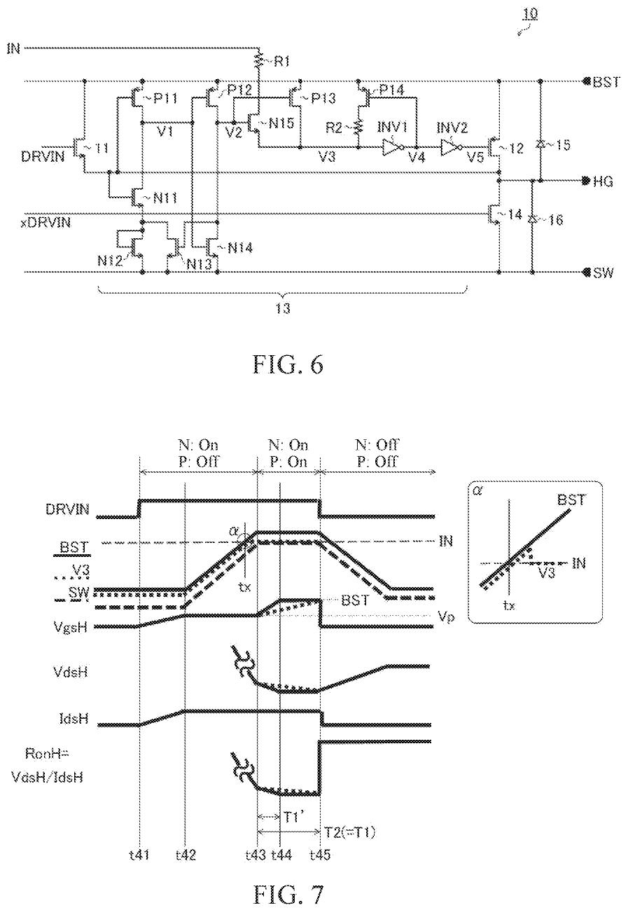

FIG. 6 shows a diagram of the driving circuit 10 according to a second embodiment. In addition to the transistors 11 and 12 and the controller 13, the driving circuit 10 of this embodiment further includes a transistor 14 (equivalent to a third transistor, for example, an NMOSFET) and diodes 15 and 16.

The drain of the transistor 14 is connected to the application end of the upper gate signal HG (=the gate of the output transistor N1). The source of the transistor 14 is connected to the application end of the switching voltage SW. The gate of the transistor 14 is connected to an application end of an inverted driving input signal xDRVIN.

With the connection above, the transistor 14 is turned on when the inverted driving input signal xDRVIN is at a high level, and is turned off when the inverted driving input signal xDRVIN is at a low level.

Moreover, the inverted driving input signal xDRVIN is fundamentally a logic inverted signal of the driving input signal DRVIN. Thus, the transistors 11 and 14 are turned on/off in a complementary manner. However, in order to prevent an overly large through current from flowing to the transistors 11 and 14, a so-called dead time (=a simultaneously off period of the transistors 11 and 14) can be set for the driving input signal DRVIN and the inverted driving input signal xDRVIN.

The cathode of the diode 15 is connected to the application end of the bootstrap voltage BST (=ON voltage), and the anode of the diode 15 is connected to the application end of the upper gate signal HG. With the connection above, the diode 15 functions as a voltage clamping element between BST and HG.

The cathode of the diode 16 is connected to the application end of the upper gate signal HG, and the anode of the diode 16 is connected to the application end of the switching voltage SW. With the connection above, the diode 16 functions as a voltage clamping element between HG and SW.

Moreover, in the driving circuit 10 of this embodiment, modifications are made to the internal structure of the controller 13. According to this drawing, the controller 13 includes transistors N11 to N15 (for example, NMOSFETs), transistors P11 to P14 (for example, PMOSFETs), resistors R1 and R2, and inverters INV1 and INV2.

The respective sources of the transistors P11 to P14 are all connected to the application end of the bootstrap voltage BST. The respective sources of the transistors N12 to N14 are all connected to the application end of the switching voltage SW.

The respective drains of the transistors P11 and N11 are both connected to an application end of a node voltage V1. The respective gates of the transistors P11 and N11 are both connected to the application end of the upper gate signal HG. The source of the transistor N11 is connected to the respective drains of the transistors N12 and N13. The gate of the transistor N12 is connected to the drain of the transistor N12. The gate of the transistor N13 is connected to the drain of the transistor N14. The respective gates of the transistors P12 and N14 are both connected to the application end of the node voltage V1. The respective drains of the transistors P12 and N14 are both connected to an application end of a node voltage V2.

The first end of the resistor R1 is connected to the application end of the input voltage IN. The second end of the resistor R1 is connected to the drain of the transistor N15. The respective gates of the transistors N15 and P13 are both connected to the application end of the node voltage V2. The drain of the transistor P14 is connected to the first end of the resistor R2. The source of the transistor N15, the drain of the transistor P13, the second end of the resistor R2, and an input terminal of the inverter INV1 are all connected to an application end of a node voltage V3. The gate of the transistor P14, an output terminal of the inverter INV1 and an input terminal of the inverter INV2 are all connected to an application end of a node voltage V4. An output terminal of the inverter INV2 and the gate of the transistor 12 are both connected to an application end of a node voltage V5.

Moreover, the transistor N15 of the above constituents is equivalent to an N-channel type transistor connected between the application end of the input voltage IN and an internal node (=the application end of the node voltage V3). Moreover, the transistor P13 is equivalent to a P-channel type transistor connected between the application end of the ON voltage (=the bootstrap voltage BST) and an internal node (=the application end of the node voltage V3).

When the driving input signal DRVIN rises to a high level (=BST), the upper gate signal HG becomes at a high level (=BST−Vth(11), wherein Vth(11) is an on threshold voltage of the transistor 11). At this point in time, the transistor P11 is turned off and the transistor N11 is turned on. Thus, the node voltage V1 is at a low level (=SW+Vth(N12), in which Vth(N12) is an on threshold voltage of the transistor N12).

When the node voltage V1 drops to a low level, the transistor P12 is turned on and the transistor N14 is turned off. As a result, the node voltage V2 becomes at a high level (=BST). As such, when the driving input signal DRVIN is at a high level, that is, when the transistor 11 is turned on, the bootstrap voltage BST (=on voltage) is applied to the respective gates of the transistors N15 and P13.

Herein, when the bootstrap voltage BST is higher than the input voltage IN, the node voltage V3 becomes at a low level (=IN). Thus, the node voltage V4 becomes at a high level, and the node voltage V5 becomes at a low level. As a result, the transistor 12 is turned on.

As such, in the driving circuit 10 of this embodiment, the controller 13 determines the ON timing of the transistor 12 according to a comparison result between the input voltage IN applied to the drain of the output transistor N1 and the bootstrap voltage BST (=ON voltage).

FIG. 7 shows a diagram of an example of a loss reduction operation according to the second embodiment. In this drawing, the driving input signal DRVIN, the bootstrap voltage BST (in a solid line), the node voltage V3 (in a point dotted line), the switching voltage SW (in a dash dotted line), and the gate-source voltage VgsH, the drain-source voltage VdsH, the drain-source current IdsH and the on resistance RonH (=VdsH/IdsH) of the output transistor N1 are sequentially depicted from top to bottom.

The drain-source voltage VdsH and the on resistance RonH are depicted in an enlarged manner in the vertical-axis direction. Moreover, similar to the right of FIG. 3 and FIG. 5 described above, this drawing represents behaviors in a low duty cycle. Moreover, an enlarged view of the area a is depicted in the dialog box.

At a timing t41, the transistor 11 is turned on when the driving input signal DRVIN rises to a high level. As a result, when the gate-source voltage VgsH of the output transistor N1 begins to rise, the drain-source current IdsH starts to flow. At this point in time, since the switching voltage SW is kept at a low level (=GND), the bootstrap voltage BST (=SW+Vc) becomes lower than the input voltage IN. Moreover, the node voltage V3 becomes at a high level (=BST−Vth(N15), wherein Vth(N15) is an on threshold voltage of the transistor N15). Accordingly, the transistor 12 is kept as off.

At a timing t42, when the increase in the drain-source current IdsH ends, the drain-source voltage VdsH begins to drop. Along with the drop of the drain-source voltage VdsH, the switching voltage SW rises and the on resistance RonH drops.

Moreover, at the timing t42, the gate-source voltage VgsH becomes temporarily stagnant (plateau region) around the plateau voltage Vp.

At a timing t43, the gate-source voltage VgsH again rises when the plateau region of the output transistor N1 expires.

Moreover, at a timing tx, the bootstrap voltage BST exceeds the input voltage IN before the plateau region expires. Accordingly, in addition to the transistor 11, the transistor 12 is also turned on because the node voltage V3 becomes at a low level (≈IN). As a result, the gate-source voltage VgsH rises drastically in comparison with the prior behaviors (equivalent to the right of FIG. 3) as indicated by the dotted line. Moreover, the drain-source voltage VdsH and the on resistance RonH also drop drastically in comparison with the prior behaviors as indicated by the dotted lines.

As such, in the driving circuit 10 (and more particularly, the controller 13) of this embodiment, a configuration of comparing the bootstrap voltage BST with the input voltage IN by the transistor N15 is used in substitution for the configuration of the first embodiment (FIG. 4) of comparing the switching voltage SW with the threshold voltage Vref by the comparator CMP (FIG. 4). According to the present configuration, the node voltage V3 is switched to a low level (≈IN) before the bootstrap voltage BST fully rises. Thus, different from the first embodiment, consideration of signal delay in the comparator CMP can be eliminated.

At a timing t44, the gate-source voltage VgsH reaches a bootstrap voltage BST, and the drain-source voltage VdsH and the on resistance RonH reach their respective minimum values. That is to say, the output transistor N1 becomes fully turned on.

At a timing t45, both the transistor 11 and the transistor 12 are turned off when the driving input signal DRVIN drops to a low level, and the high-level period T2 of the switching voltage SW expires.

In the series of operations of loss reduction, the same as the first embodiment above, only the transistor 11 is turned on at the beginning of the on-transition period (=timings t41 to t43) of the output transistor N1, and the transistor 12 is also turned on in the middle (=timing t43) of the on-transition period of the output transistor N1.

As a result, the on resistance RonH is minimized within a shorter time after the plateau region expires. Thus, a Ron loss period T1′ (=timings t43 to t44) is shortened compared to the conventional Ron loss period T1 (=timings t43 to t45). In other words, the Ron loss period T1′ is shorter than the high-level period T2 (=timings t43 to t45) of the switching voltage SW (T1′<T2=T1). Therefore, the prior switching loss (Ron loss) is unlikely significant.

Moreover, the operations for loss reduction of the first and second embodiments can be implemented regardless of the on duty cycle Don. Thus, the effect of loss reduction in a low duty cycle is naturally satisfactory, and such effect of loss reduction in a high duty cycle can also be much anticipated.

### Variation Example

In the embodiments, configurations in which the on resistance of the output transistor N1 forming the half-bridge output stage is minimized to thereby reduce the switching loss (Ron loss) in a low duty cycle are illustrated. However, it should be noted that the applicable targets of the present disclosure are not limited to the examples above.

For example, in one variation example, a configuration in which the on resistance of the synchronous rectifier transistor N2 is minimized to thereby reduce the switching loss (Ron loss) in a high duty cycle can also be considered.

Moreover, the present disclosure is not only useful for driving GaN devices but also useful for driving Si devices.

### <Driving Circuit (Third Embodiment)>

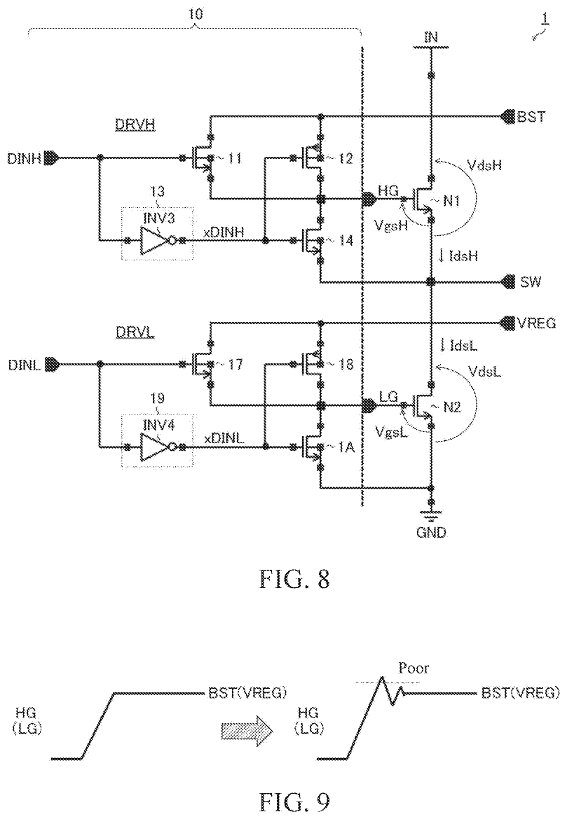

FIG. 8 shows a diagram of the driving circuit 10 according to a third embodiment. The driving circuit 10 of this embodiment, as a constituent of an upper driver DRVH for driving the output transistor N1, includes the transistors 11 and 12, the controller 13 and the transistor 14 described above. The controller 13 further includes an inverter INV3.

The drain of the transistor 11 and the source of the transistor 12 are both connected to the application end of the bootstrap voltage BST (=the drain of the output transistor N1). The source of the transistor 11 and the respective drains of the transistors 12 and 14 are all connected to the application end of the upper gate signal HG (=the gate of the output transistor N1). The source of the transistor 14 is connected to the application end of the switching voltage SW (=the source of the output transistor N1). The gate of the transistor 11 and an input terminal of the inverter INV3 are both connected to an application end of an upper driving input signal DINH. The respective gates of the transistors 12 and 14 are both connected to an application end of an inverted upper driving input signal xDINH (=an output terminal of the inverter INV3).

The transistor 11 is turned on when the upper driving input signal DINH is at a high level, and the transistor 11 is turned off when the upper driving input signal DINH is at a low level.

The transistor 12 is turned off when the inverted upper driving input signal xDINH is at a high level, and the transistor 12 is turned on when the inverted upper driving input signal xDINH is at a low level.

The transistor 14 is turned on when the inverted upper driving input signal xDINH is at a high level, and the transistor 14 is turned off when the inverted upper driving input signal xDINH is at a low level.

The inverter INV3 inverts the logic level of the upper driving input signal DINH and generates the inverted upper driving input signal xDINH. The inverted upper driving input signal xDINH is at a low level when the upper driving input signal DINH is at a high level, and the inverted upper driving input signal xDINH is at a high level when the upper driving input signal DINH is at a low level.

Moreover, after the upper driving input signal DINH rises to a high level, the inverted upper driving input signal xDINH delays a signal delay amount of the inverter INV3 and reduces to a low level. Thus, only the transistor 11 is turned on at beginning of the on-transition period of the output transistor N1, and the transistor 12 is also turned on in the middle of the on-transition period.

Moreover, the driving circuit 10 of this embodiment, serving as a constituent of a lower driver DRVL driving the synchronous rectifier transistor N2, includes a transistor 17 (equivalent to a first transistor, for example, an NMOSFET, of the lower driver DRVL), a transistor 18 (equivalent to a second transistor, for example, a PMOSFET of the lower driver DRVL), a controller 19, and a transistor 1A (equivalent to a third transistor, for example, an NMOSFET, of the lower driver DRVL). The controller 19 further includes an inverter INV4.

The drain of the transistor 17 and the source of the transistor 18 are both connected to an application end of an internal power voltage VREG (=the drain of the synchronous rectifier transistor N2). The source of the transistor 17 and the respective drains of the transistors 18 and 1A are all connected to an application end of the lower gate signal LG (=the gate of the synchronous rectifier transistor N2). The source of the transistor 1A is connected to the ground terminal, that is, the application end of the ground voltage GND (=the source of the synchronous rectifier transistor N2). The gate of the transistor 17 and an input terminal of the inverter INV4 are both connected to an application end of a lower driving input signal DINL. The respective gates of the transistors 18 and 1A are both connected to an application end of an inverted lower driving input signal xDINL (=an output terminal of the inverter INV4).

The transistor 17 is turned on when the lower driving input signal DINL is at a high level, and the transistor 17 is turned off when the lower driving input signal DINL is at a low level.

The transistor 18 is turned off when the inverted lower driving input signal xDINL is at a high level, and the transistor 18 is turned on when the inverted lower driving input signal xDINL is at a low level.

The transistor 1A is turned on when the inverted lower driving input signal xDINL is at a high level, and the transistor 1A is turned off when the inverted lower driving input signal xDINL is at a low level.

The inverter INV4 inverts the logic level of the lower driving input signal DINL and generates the inverted lower driving input signal xDINL. The inverted lower driving input signal xDINL is at a low level when the lower driving input signal DINL is at a high level, and the inverted lower driving input signal xDINL is at a high level when the lower driving input signal DINL is at a low level.

Moreover, after the lower driving input signal DINL rises to a high level, the inverted lower driving input signal xDINL delays a signal delay amount of the inverter INV4 and reduces to a low level. Thus, only the transistor 17 is turned on at beginning of the on-transition period of the synchronous rectifier transistor N2, and the transistor 18 is also turned on in the middle of the on-transition period.

### <Consideration for Ringing of Gate Signals>

FIG. 9 shows a diagram of a situation in which ringing of the upper gate signal HG occurs when the transistor 11 above is not yet introduced. The left of this drawing depicts rising behaviors of the upper gate signal HG that are not accompanied with ringing (ideal behaviors), while the right of this drawing depicts rising behaviors of the upper gate signal HG that are accompanied with ringing.

When the N-channel type transistor 11 is not introduced, only the P-channel type transistor 12 is used to have the upper gate signal HG rise to a high level during the on-transition period of the output transistor N1. In this case, the upper gate signal HG instantly rises to the bootstrap voltage BST (referring to the left of this drawing) via the transistor 12.

Thus, when ringing occurs in the upper gate signal HG due to certain reasons, there is a concern that the upper gate signal HG may exceed the gate threshold voltage of the output transistor N1 and overshoot (referring to the right of this drawing). More particularly, since the gate threshold voltage of GaN devices is in general lower than that of Si devices, measures against overshoot become more important.

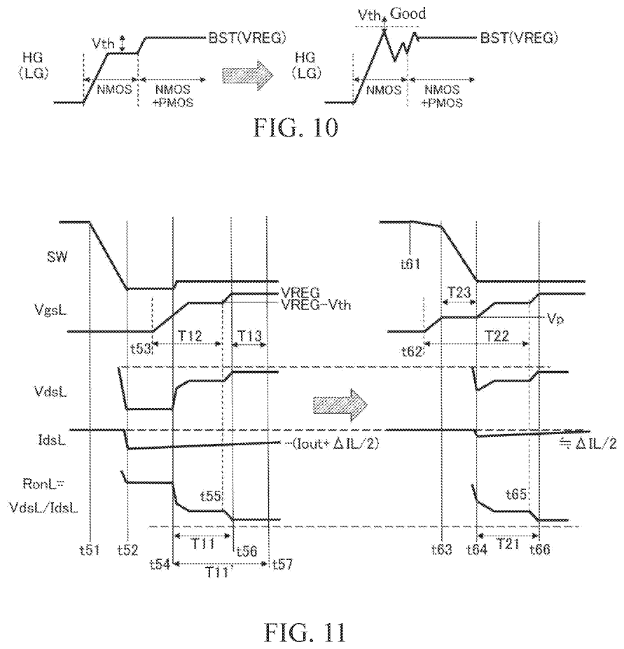

FIG. 10 shows a diagram of a situation in which ringing of the upper gate signal HG is inhibited by introducing the transistor 11 above. Similar to FIG. 9, the left of this drawing depicts rising behaviors of the upper gate signal HG that are not accompanied with ringing (ideal behaviors), while the right of this drawing depicts rising behaviors of the upper gate signal HG that are accompanied with ringing.

When the N-channel type transistor 11 is introduced, only the transistor 11 is turned on at the beginning of the on-transition period of the output transistor N1. In this case, the upper gate signal HG only rises to a voltage of the bootstrap voltage BST subtracted by the on threshold voltage Vth of the transistor 11 (=BST-Vth) (referring to the right of this drawing). Thus, even if ringing occurs in the upper gate signal HG, the upper gate signal HG is unlikely to exceed the gate threshold voltage of the output transistor N1 and overshoot.

Moreover, in FIG. 9 and FIG. 10, the description is focused on the upper gate signal HG, but the same details may apply to the lower gate signal LG.

### <Consideration for on Timing Control of PMOSFET>

As having been described so far, in the configuration in which an NMOSFET and a PMOSFET connected in parallel are sequentially turned on, it is critical to appropriately set the ON timing of the PMOSFET.

For example, in a heavy load and in a light load, the plateau region of the synchronous rectifier transistor N2 (=the region in which the gate-source voltage VgsL is temporarily stagnant around the plateau voltage Vp) is different. More specifically, the plateau region of the synchronous rectifier transistor N2 tends to be longer for a lighter load.

However, when the ON timing of the transistor 18 is set to match an optimal timing of a light load, the ON timing of the transistor 18 in a heavy load is later than an optimal timing of the heavy load. As a result, the Ron loss cannot be fully inhibited.

Conversely, when the ON timing of the transistor 18 is set to match an optimal timing of a heavy load, the ON timing of the transistor 18 in a light load is earlier than an optimal timing of the light load. As a result, ringing cannot be fully inhibited.

FIG. 11 shows a diagram of a situation in which a deviation corresponding to heavy and light loads occurs under the ON timing control of the transistor 18. In this drawing, the switching voltage SW, and a gate-source voltage VgsL, a drain-source voltage VdsL, a drain-source current IdsL and an on resistance RonL (=VdsL/IdsL) of the synchronous rectifier transistor N2 are sequentially depicted from top to bottom.

The drain-source voltage VsdL and the on resistance RonL are depicted in an enlarged manner in the vertical-axis direction. Moreover, the left of this drawing represents behaviors in a heavy load, and the right of this drawing represents behaviors in a light load.

Intervals T11 (=timings t54 to t56) and T21 (=timings t64 to t66) respectively represent intervals in which the on resistance RonL of the synchronous rectifier transistor N2 is relatively high. That is to say, the intervals T11 and T21 are equivalent to the Ron loss interval described above.

Intervals T12 (=timings t53 to t55) and T22 (=timings t62 to t65) respectively represent intervals of an on-state of the transistor 17 and an off-state of the transistor 18 (=an NMOS driving interval).

An interval T13 (=timings t56 to t57) represents an NMOS driving prolonged interval set for a heavy load in the consideration of the plateau region of a light load. An interval T23 (=timings t63 to t64) represents the plateau region of a light load.

In the intervals T11 and T21, the gate-source voltage VgsL only rises to a voltage value of the internal power voltage VREG subtracted by the on threshold voltage Vth of the transistor 18 (=VREG-Vth). Thus, in the intervals T11 and T21, the synchronous rectifier transistor N2 is not fully turned on.

However, when the ON timing of the transistor 18 is set to match an optimal timing of a light load, the ON timing of the transistor 18 in a heavy load is later than an optimal timing of the heavy load.

According to this drawing, the ON timing of the transistor 18 is not a timing at which the interval T11 expires, but is a timing at which the interval T13 has further elapsed from the plateau region of the light load. That is to say, the interval T11 is prolonged to an interval T11′ (=timings t54 to t57). As a result, the Ron loss is increased. More particularly, when the switching frequency increases, the ratio of the interval T11′ to a low-level period of the switching voltage SW increases. Therefore, the Ron loss easily becomes significant.

### <Driving Circuit (Fourth Embodiment)>

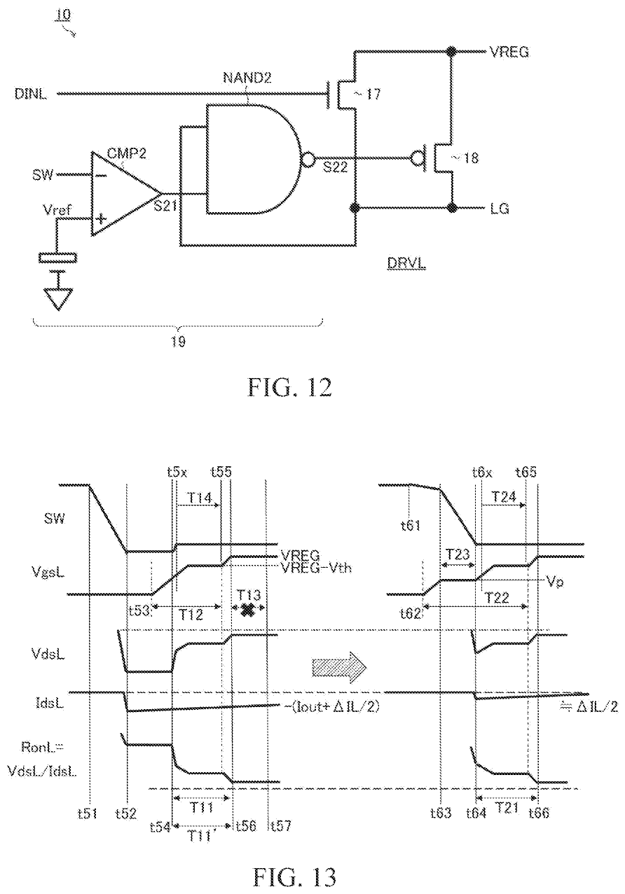

FIG. 12 shows a diagram of the driving circuit 10 according to a fourth embodiment. In the driving circuit 10 of this embodiment, the controller 19 included in the lower driver DRVL performs ON timing control of the transistor 18 by means of turning on the transistor 17 at the beginning of the on-transition period of the synchronous rectifier transistor N2 (=a high-level transition period of the lower gate signal LG), and also turning on the transistor 18 in the middle of the on-transition period.

According to this drawing, the controller 19 includes a comparator CMP2 and a negative logic product gate NAND2.

The comparator CMP2 compares the switching voltage SW input to an inverting input terminal (−) with a predetermined threshold voltage Vref (for example, VREG/2) input to a non-inverting input terminal (+) to generate a comparison signal S21. Thus, the comparison signal S21 is at a high level when the switching voltage SW is lower than the threshold voltage Vref, and is at a low level when the switching voltage SW is higher than the threshold voltage Vref.

The negative logic product gate NAND2 (equivalent to a logic gate) generates, according to the comparison signal S21 and the lower gate signal LG (equivalent to a control signal of the synchronous rectifier transistor N2 serving as a driving target of the lower driver DRVL), a negative logic product signal S22 to turn on/off the transistor 18. The negative logic product signal S22 is at a high level when at least one of the comparison signal S21 and the lower gate signal LG is at a low level, and is at a low level when both of the comparison signal S21 and the lower gate signal LG are at a high level.

As such, the controller 19 of this configuration example determines the ON timing of the transistor 18 according to the comparison result between the switching voltage SW appearing at one end (the source) of the synchronous rectifier transistor N2 and the predetermined threshold voltage Vref.

According to this drawing, the controller 19 turns on the transistor 18 when the switching voltage SW is lower than the threshold voltage Vref and the lower gate signal LG is at a high level (=the logic level when ON).

FIG. 13 shows a diagram of a situation in which a deviation corresponding to heavy and light loads is relieved under the ON timing control of the transistor 18. In this drawing, similar to FIG. 11, the switching voltage SW, and the gate-source voltage VgsL, the drain-source voltage VdsL, the drain-source current IdsL, and the on resistance RonL (=VdsL/IdsL) of the synchronous rectifier transistor N2 are sequentially depicted from top to bottom.

The drain-source voltage VsdL and the on resistance RonL are depicted in an enlarged manner in the vertical-axis direction. Moreover, the left of this drawing represents behaviors in a heavy load, and the right of this drawing represents behaviors in a light load.

Timings t5x and t6x newly added to this drawing respectively represent timings when it is detected that the switching voltage SW is lower than the threshold voltage Vref and the lower gate signal LG is at a high level (=the logic level when ON).

The ON timing of the transistor 18 may be set to be timings after signal delay intervals T14 and T24 of the negative logic product gate NAND2 and a subsequent pre-driver (not shown) have elapsed from the timings t5x and t6x.

The driving circuit 10 of this embodiment can variably set the ON timing of the transistor 18 according to light or heavy loads. Thus, in a heavy load, the interval T11 does not need to be prolonged to the interval T11′. Accordingly, reducing the Ron loss and inhibiting ringing can both be attained.

### Conclusion

A summary of the various embodiments of the above description is provided below.

For example, a driving circuit disclosed in the present application is configured (as a first configuration) to include: a first transistor and a second transistor, configured to be connected in parallel between a control end of a transistor to be driven and an application end of an ON voltage; and a controller, configured to turn on the first transistor at beginning of an on-transition period of the transistor to be driven, and turn on the second transistor in the middle of the on-transition period.

The driving circuit of the first configuration may also be configured as follows (a second configuration), wherein the first transistor is of a first channel type and the second transistor is of a second channel type different from the first channel type.

The driving circuit of the first or second configuration may also be configured as follows (a third configuration), wherein the controller turns on the second transistor after a plateau region of the transistor to be driven expires.

The driving circuit of any one of the first to third configurations may also be configured as follows (a fourth configuration), wherein the controller determines an ON timing of the second transistor according to a comparison result between a switching voltage appearing at one end of the transistor to be driven and a predetermined threshold voltage.

The driving circuit of the fourth configuration may also be configured as follows (a fifth configuration), wherein the controller includes: a comparator, configured to compare the switching voltage and the threshold voltage to generate a comparison signal; and a logic gate, configured to turn on/off the second transistor according to the comparison signal and a control signal for the transistor to be driven.

The driving circuit of the fifth configuration may also be configured as follows (a sixth configuration), wherein the transistor to be driven is connected between an application end of an input voltage and an application end of the switching voltage, and the controller turns on the second transistor when the switching voltage is higher than the threshold voltage and the control signal is at an on-state logic level.

The driving circuit of the fifth configuration may also be configured as follows (a seventh configuration), wherein the transistor to be driven is connected between an application end of the switching voltage and an application end of a reference voltage, and the controller turns on the second transistor when the switching voltage is lower than the threshold voltage and the control signal is at an on-state logic level.

The driving circuit of any one of the first to third configurations may also be configured as follows (an eighth configuration), wherein the controller determines an ON timing of the second transistor according to a comparison result between an input voltage applied to one end of the transistor to be driven and the ON voltage.

The driving circuit of the eighth configuration may also be configured as follows (a ninth configuration), wherein the controller includes: an N-channel transistor, connected between an application end of the input voltage and an internal node; and a P-channel transistor, connected between the application end of the ON voltage and the internal node, the ON voltage is applied to control ends of the N-channel transistor and the P-channel transistor when the first transistor is turned on; and the second transistor is turned on/off according to a node voltage appearing at the internal node.

The driving circuit of any one of the first to ninth configurations may also be configured as follows (a tenth configuration), wherein the transistor to be driven is a GaN device.

The driving circuit of any one of the first to tenth configurations may also be configured as follows (an eleventh configuration), wherein a minimum on time of the transistor to be driven is less than 20 ns.

Moreover, a switching power supply disclosed by the present application may be configured (a twentieth configuration) to include the driving circuit according to any one of the first to eleventh configurations.

### OTHER VARIATION EXAMPLES

In addition to the embodiments, various modifications may be made to the technical features disclosed by the present application without departing from the scope of the technical inventive subject thereof. That is to say, all aspects described in the embodiments are illustrative rather than restrictive. Moreover, it shall be understood that the technical scope of the present disclosure is defined by the appended claims, and encompasses all equivalent meanings covered by the scope and all modifications made within the scope of the appended claims.

1. A driving circuit, comprising:
a first transistor and a second transistor, configured to be connected in parallel between a control end of a transistor to be driven and an application end of an ON voltage; and
a controller, configured to turn on the first transistor at beginning of an on-transition period of the transistor to be driven, and turn on the second transistor in middle of the on-transition period.

2. The driving circuit of claim 1, wherein the first transistor is of a first channel type and the second transistor is of a second channel type different from the first channel type.

3. The driving circuit of claim 1, wherein the controller turns on the second transistor after a plateau region of the transistor to be driven expires.

4. The driving circuit of claim 1, wherein the controller determines an ON timing of the second transistor according to a comparison result between a switching voltage appearing at one end of the transistor to be driven and a predetermined threshold voltage.

5. The driving circuit of claim 4, wherein the controller includes:
a comparator, configured to compare the switching voltage and the threshold voltage to generate a comparison signal; and
a logic gate, configured to turn on/off the second transistor according to the comparison signal and a control signal for the transistor to be driven.

6. The driving circuit of claim 5, wherein
the transistor to be driven is connected between an application end of an input voltage and an application end of the switching voltage, and
the controller turns on the second transistor when the switching voltage is higher than the threshold voltage and the control signal is at an on-state logic level.

7. The driving circuit of claim 5, wherein
the transistor to be driven is connected between an application end of the switching voltage and an application end of a reference voltage, and
the controller turns on the second transistor when the switching voltage is lower than the threshold voltage and the control signal is at an on-state logic level.

8. The driving circuit of claim 1, wherein the controller determines an ON timing of the second transistor according to a comparison result between an input voltage applied to one end of the transistor to be driven and the ON voltage.

9. The driving circuit of claim 8, wherein
the controller includes:
an N-channel transistor, connected between an application end of the input voltage and an internal node; and
a P-channel transistor, connected between the application end of the ON voltage,
the ON voltage is applied to control ends of the N-channel transistor and the P-channel transistor when the first transistor is turned on, and
the second transistor is turned on/off according to a node voltage appearing at the internal node.

10. The driving circuit of claim 1, wherein the transistor to be driven is a GaN device.

11. The driving circuit of claim 1, wherein a minimum on time of the transistor to be driven is less than 20 ns.

12. A switching power supply, comprising the driving circuit of claim 1.

13. A switching power supply, comprising the driving circuit of claim 2.

14. A switching power supply, comprising the driving circuit of claim 3.

15. A switching power supply, comprising the driving circuit of claim 4.

16. A switching power supply, comprising the driving circuit of claim 5.

17. A switching power supply, comprising the driving circuit of claim 8.

18. A switching power supply, comprising the driving circuit of claim 9.

19. A switching power supply, comprising the driving circuit of claim 10.

20. A switching power supply, comprising the driving circuit of claim 11.
